(19) United States
(12) Patent Application Publication
(10) Pub. No.: US 2026/0286749 A1
(43) Pub. Date: Sep. 24, 2026

(54) LOCK DEVICE FOR A MOTOR VEHICLE

(71) Applicant: MAGNA CLOSURES INC., Newmarket (CA)

(72) Inventors: Ann-Margaret MOZOLA, Newmarket (CA); Francesco CUMBO, Newmarket (CA); Ping XU, Newmarket (CA)

(21) Appl. No.: 19/574,247

(22) Filed: Mar. 20, 2026

(30) Foreign Application Priority Data
Mar. 24, 2025 (CN) 202510349802.1

(51) Int. Cl. E05B 81/24; E05B 81/06; E05B 81/34; E05B 81/42; E05B 85/04

(52) U.S. Cl. CPC E05B 81/25; E05B 81/06; E05B 81/34; E05B 81/42; E05B 85/04

(57) ABSTRACT

A lock device for a motor vehicle door has a support member and a latch mechanism mounted to the support member. The latch release mechanism has a coupled state and an uncoupled state. In the coupled state, the latch release mechanism is able to actuate the latch mechanism, and in the uncoupled state the latch release mechanism, when actuated, is unable to actuate the latch mechanism. Lock device further includes an actuating unit and a switching mechanism operably coupled to the actuating unit. The switching mechanism configured to switch the latch release mechanism between the coupled state and the uncoupled state only when the actuating unit moves from a home position toward an actuating position.

### CROSS-REFERENCE TO RELATED APPLICATIONS

This application claims the benefit of Chinese Patent Application Ser. No. 202510349802.1, filed March 24, 2025, which is incorporated herein by reference in its entirety.

### TECHNICAL FIELD

The present disclosure relates to latch systems for motor vehicles. More particularly, the present disclosure relates to a lock device and to a motor vehicle equipped with such a lock device.

### BACKGROUND

This section provides background information related to the present application, which does not necessarily constitute prior art.

A vehicle closure panel—such as a door for a vehicle cabin—is arranged to move relative to the vehicle body between an open position and a closed position, and typically includes a lock device. The lock device is used to latch the closure panel when the closure panel is in the closed position. Additionally, the lock device may be released to allow the closure panel to move to the open position.

In the related art, a lock device typically includes a latch mechanism for latching the vehicle closure panel, and a latch release mechanism for unlatching the closure panel. The latch release mechanism is usually connected to a handle on the vehicle closure panel and has a coupled (enabled) state and a decoupled (disabled) state: in the coupled state, the latch release mechanism is able to engage with the latch mechanism so that the user can unlatch the vehicle closure panel by mechanically actuating the latch mechanism through the handle; in the decoupled state, the latch release mechanism is unable to engage with the latch mechanism so that the user is prevented from unlatching the closure panel through the handle.

A lock device further typically includes a motor and an actuating gear for switching the latch release mechanism between the coupled state and the uncoupled state. The forward and reverse rotation of the motor drives the actuating gear from an original home position in opposite directions to achieve switching between states. However, this may cause undesired switching of the latch release mechanism when the actuating gear returns to the original home position after each actuation, preventing the latch release mechanism from remaining in the desired state. Furthermore, since both the forward and reverse rotations of the motor are used for switching the latch release mechanism, additional actuating units are often needed to achieve other functions. Excess actuating units increase the cost, complexity, power consumption, and size of the lock device.

### SUMMARY

An object of the present disclosure is to solve one or more of the technical problems described above.

This disclosure relates to a lock device for a motor‑vehicle door. The lock device includes a support member on which a latch mechanism is mounted. A latch release mechanism is provided that has a coupled state and an uncoupled state. In the coupled state, the latch release mechanism is able to actuate the latch mechanism, and in the uncoupled state actuation of the latch release mechanism does not actuate the latch mechanism.

[ 009 ] In accordance with one aspect, a lock device for a motor vehicle door is provided, the lock device includes a support member, a latch mechanism (mounted to the support member, a latch release mechanism having a coupled state and an uncoupled state, wherein in the coupled state the latch release mechanism is able to actuate the latch mechanism, and in the uncoupled state the latch release mechanism when actuated is unable to actuate the latch mechanism, an actuating unit, and a switching mechanism operable coupled to the actuating unit, the switching mechanism configured to switch the latch release mechanism between the coupled state and the uncoupled state only when the actuating unit moves from a home position toward an actuating position.

In a related aspect, the actuating unit is configured to return to the home position from the actuating position under the influence of a spring bias.

In a related aspect, the actuating unit is configured to engage with the latch mechanism to release the lock device when the actuating unit moves toward a releasing position.

In a related aspect, the lock/unlock mechanism is operated by the switching mechanism to change the latch release mechanism (400) between the coupled state and the uncoupled state.

In a related aspect, the actuating unit comprises a power release gear having a cam surface and a motor operably coupled to the power release gear for rotating the power release gear in a first direction and in a second direction.

In a related aspect, the cam surface is configured to push against a surface of the lock/unlock mechanism when the actuating unit moves from the home position toward the actuating position.

In a related aspect, the cam surface is configured to slide against the surface of the lock/unlock mechanism when the actuating unit moves from the home position toward the actuating position.

In a related aspect, the cam surface is configured to disengage from the surface of the lock/unlock mechanism when the actuating unit moves from the actuating position to the home position.

In a related aspect, wherein the lock/unlock mechanism comprises a rocker, wherein the actuating unit is configured to toggle the rocker between a locking position in which the latch release mechanism is in the uncoupled state, and an unlocking position in which the latch release mechanism is in the coupled state.

In a related aspect, the switching mechanism comprises a lever assembly operably coupled to the actuating unit and to the lock/unlock mechanism, wherein the lever assembly is not pivotally mounted on the power release gear.

In a related aspect, the lever assembly comprises a return arm pivotally coupled to the support member, wherein the return arm is pivoted by the actuating unit, and wherein the pivoting of the return arm causes the latch release mechanism to switch between the coupled state and the uncoupled state.

In a related aspect, the lever assembly further comprises a second drive arm pivotally mounted to the return arm, wherein the cam surface is configured to slidably engage against a surface of the return arm to cause the second drive arm to move and engage with the switching mechanism.

In a related aspect, the return arm is biased towards a non-actuated position, and wherein the cam surface is configured to move the return arm against a bias toward an actuated position as the actuating unit moves toward the actuating.

In a related aspect, the lock device further includes a lock link operably coupled to the switching mechanism and to the latch release mechanism, wherein the lock link is movable by the switching mechanism to switch the latch release mechanism between the coupled state and the uncoupled state.

In a related aspect, the lock link is a sliding member.

In a related aspect, the latch release mechanism is associated with one of an inside door handle and an outside door handle.

In a related aspect, the switching mechanism is configured such that the latch release mechanism not switched when the actuating unit returns toward the home position or moves in an opposite second direction.

In a related aspect, the lock link is slidably movable in a direction along its longitudinal axis, wherein the latch release mechanism is associated with the inside door handle, the latch release mechanism comprises a coupled state to connect the inside door handle to the latch mechanism and the uncoupled state to disconnect the inside door handle from the latch mechanism, wherein the lock device comprises another latch release mechanism that is associated with the outside door handle, wherein the other latch release mechanism comprises a coupled state to connect the outside door handle to the latch mechanism and the uncoupled state to disconnect the outside door handle from the latch mechanism; and wherein the switching mechanism is operably coupled to the lock link to cause the lock link to move and change the states of both latch release mechanism and the other latch release mechanism.

In a related aspect, the support member is a frame plate, wherein the latch mechanism includes a ratchet pivotally supported on the frame plate by a ratchet pin, wherein the ratchet is movable between a striker release position in which the ratchet is positioned to release a striker and a striker capture position in which the ratchet is positioned to retain the striker, with the ratchet being biased toward the striker release position and having a closing notch, and a pawl pivotally supported on the frame plate by a pawl pin for movement between a ratchet holding position in which the pawl is positioned to hold the ratchet in the striker capture position and a ratchet releasing position in which the pawl is located to permit movement of the ratchet to the striker release position, wherein the pawl is biased toward the ratchet holding position, wherein the latch release mechanism is able to move the pawl from the ratchet holding position to the ratchet releasing position when the latch release mechanism is in the coupled state and wherein the latch release mechanism is unable to move the pawl from the ratchet holding position to the ratchet releasing position when the latch release mechanism is in the uncoupled state.

In accordance with another aspect, a lock device for a motor vehicle door, the lock device including a support member, a latch mechanism having a ratchet and a pawl mounted to the support member, a latch release mechanism operably connected to a door handle and to the pawl, wherein the latch release mechanism has a coupled state coupled state and an uncoupled state, wherein in the coupled state the door handle is able to actuate the pawl, and in the uncoupled state the door handle when actuated is unable to actuate the latch mechanism, a bistable mechanism operable to switch the latch release mechanism between the coupled state and the uncoupled state; and an actuating unit having a power release gear moveable away from a home position in a first direction and moveable away from the home position in a second opposite direction, wherein the power release gear is operable to move the pawl when moved away from the home position in a second opposite direction, and wherein the power release gear is operable to actuate the bistable mechanism to switch the latch release mechanism between the coupled state and the uncoupled state only when the power release gear moves from the home position in the first direction.

### DESCRIPTION OF THE DRAWINGS

The features and characteristics described above and additional features will become clearer from the following detailed description with reference to the accompanying drawings, which are provided as examples and are not necessarily drawn to scale. In the drawings, the same reference numerals indicate the same components:

FIG. 1 is a perspective schematic view of a portion of a motor vehicle according to the present disclosure;

FIG. 2 is a schematic view of the latch mechanism of a lock device according to an embodiment shown in FIG. 1;

FIG. 3 is a schematic view of the latch release mechanism and switching mechanism of a lock device according to an embodiment shown in FIG. 1, where the actuating gear of the switching mechanism is in the home position and the latch release mechanism is in the coupled state;

FIG. 4 is another schematic view of the latch release mechanism and switching mechanism of the lock device shown in FIG. 1, where the actuating gear moves from the home position in a counterclockwise direction for a first actuation into the actuating position, and the latch release mechanism is in the uncoupled state;

FIG. 5 is another schematic view of the latch release mechanism and switching mechanism of the lock device shown in FIG. 1, where the actuating gear returns from the actuating position in a clockwise direction to the original position, and the latch release mechanism remains in the disengaged state;

FIG. 6 is another schematic view of the latch release mechanism and switching mechanism of the lock device shown in FIG. 1, where the actuating gear moves from the home position in a counterclockwise direction for a second actuation into the actuating position, and the latch release mechanism is in the coupled state;

FIG. 7 is another schematic view of the latch release mechanism and switching mechanism of the lock device shown in FIG. 1, where the actuating gear returns from the actuating position in a clockwise direction to the home position, and the latch release mechanism remains in the coupled state;

FIG. 8 is a schematic view of another embodiment of the lock device shown in FIG. 1, illustrating the latch release mechanism, the secondary latch release mechanism, and the switching mechanism, where the actuating gear is in the home position and the latch release mechanism is in the coupled state; and

FIG. 9 is a schematic view of another embodiment of a switching mechanism for lock device shown in FIG. 1.

### DETAILED DESCRIPTION OF EXAMPLE EMBODIMENTS

The preferred embodiments of the present disclosure will now be described in detail with reference to the accompanying drawings. The following description is merely exemplary in nature and is not intended to limit the present configurations or its applications or uses.

The present disclosure provides a lock device for a motor vehicle and a motor vehicle equipped with such a lock device.

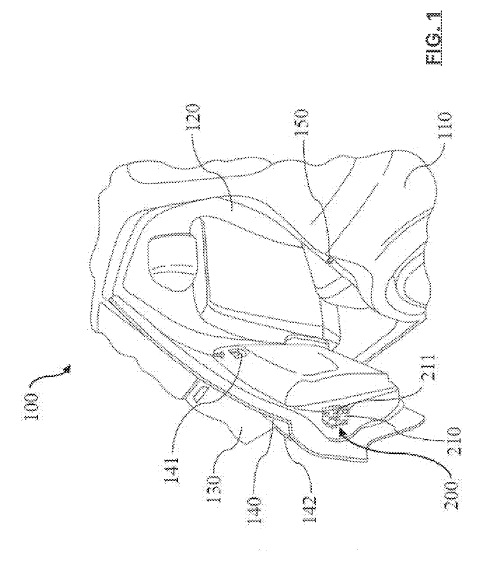

FIG. 1 is a perspective schematic view of a portion of a motor vehicle 100 according to the present disclosure. As shown in FIG. 1, the motor vehicle 100 includes a vehicle body 110, a cabin 120 defined by the vehicle body 110, and at least one door for the cabin (as an example of a “vehicle closure panel”), such as a front door 130 and a rear door 140. The front door 130 and the rear door 140 are arranged (e.g., hinged) such that they can move relative to the vehicle body 110 between an open position and a closed position.

In FIG. 1, the front door 130 is shown in the closed position and the rear door 140 is shown in the open position. A lock device 200 is provided on each of the front door 130 and the rear door 140. The lock device 200 is arranged on the trailing-edge surface of either the front door 130 or the rear door 140 and is configured to releasably engage with a striker 150 provided on the vehicle body 110 when the door 130, 140 is in the closed position. A door handle is arranged to be operable by a user to allow the lock device 200 to disengage from the striker 150 to unlatch the door 130, 140, thereby allowing the door 130, 140 to move to the open position. For example, the lock device 200 can be disengaged from the striker 150 through mechanical actuation via the inner handle 141 or the outer handle 142 on the rear door 140, thereby allowing the rear door 140 to be opened.

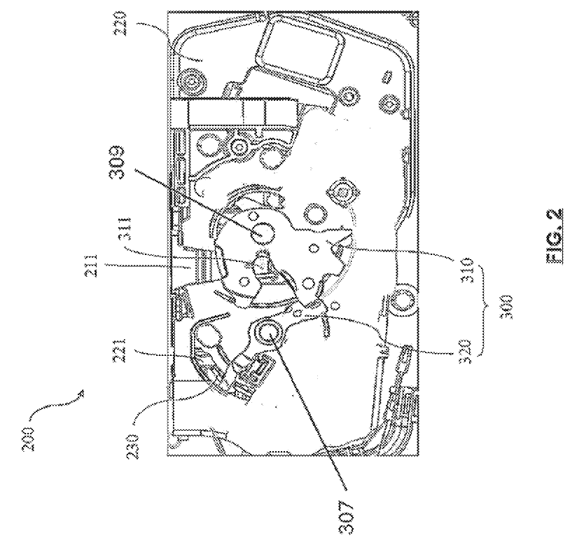

FIGS. 2 to 7 illustrate an embodiment of the lock device 200 shown in FIG. 1 for the motor vehicle 100. For clarity, the outer casing 210 (FIG. 1) of the lock device 200 has been removed. The following description uses as an example the lock device 200 installed on the rear door 140. It will be understood that the lock device 200 may also be applied to the front door 130. In addition, the lock device 200 may be provided on a trunk lid (not shown; another example of a “vehicle closure panel”) or an engine hood (not shown; yet another example of a “vehicle closure panel”) of the motor vehicle 100.

As shown in FIG. 2, the lock device 200 includes a support member 220 located within the outer casing 210. The support member 220 is illustratively shown as a plate-like member, and may also be referred to as a frame plate. The support member 220 has opposite first and second sides in the thickness direction. A through-slot 221 is formed through the support member 220 from its first side to its second side. A latch mechanism 300 is provided on the first side of the support member 220. The latch mechanism 300 is movable between a striker-capture position, in which the latch mechanism 300 captures a striker 150 on the vehicle body 110, and a striker-release position, in which the latch mechanism releases the striker 150. The latch mechanism 300 is illustratively shown as a ratchet-and-pawl assembly. Specifically, the latch mechanism 300 includes a ratchet 310 and a pawl 320. Both the ratchet 310 and the pawl 320 are pivotably mounted on the support member 220. The ratchet 310 is pivotally mounted to the support member 220 via a ratchet pin 309. The ratchet 310 is movable between the striker-capture position and the striker-release position. In the striker-capture position, the ratchet 310 retains the striker 150 by means of a striker slot 311 formed in the ratchet 310 and keeps the rear door 140 in the closed position. In the striker-release position, the ratchet 310 allows the striker 150 to be released from a fish-mouth opening 211 formed by the outer casing 210 and the support member 220 of the lock device 200, so that the rear door 140 may move to the open position. A ratchet biasing member (not shown), such as a biasing spring, is provided on the ratchet 310 to bias the ratchet 310 toward its striker-release position. The pawl 320 is movable between a ratchet-holding position and a ratchet-releasing position. In the ratchet-holding position, the pawl 320 engages with a notch on the ratchet to keep the ratchet 310 in its striker-capture position. In the ratchet-releasing position, the pawl 320 is disengaged with the ratchet 310 to allow the ratchet 310 to move to its striker-release position, for example under the biasing force of the ratchet biasing member. A pawl biasing member (not shown), such as a biasing spring, is provided on the pawl 320 to bias the pawl 320 toward its ratchet-holding position. The pawl 320 is pivotally mounted to the support member 220 via the pawl pin 307.

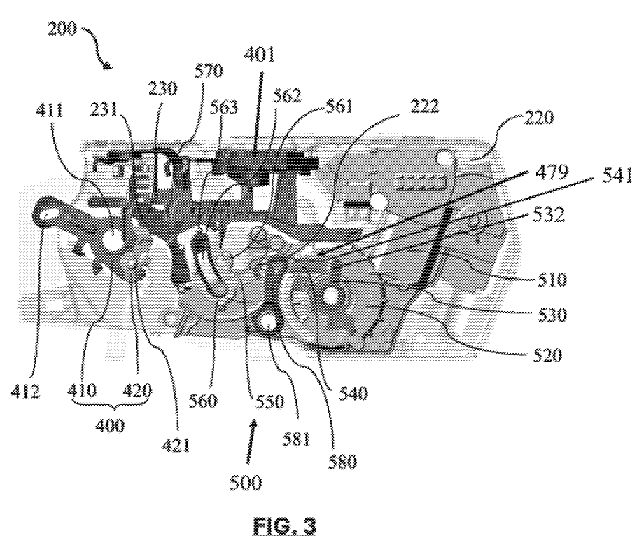

As shown in FIGS. 3 to 7, a latch release mechanism 400 is provided on the second side of the support member 220. The input of the latch release mechanism 400 is connected to the inner handle 141 or the outer handle 142 on the rear door 140 so that it may be mechanically actuated via the inner handle 141 or the outer handle 142. The output of the latch release mechanism 400 can selectively engage with the latch mechanism 300 when the latch release mechanism 400 is coupled (e.g. see FIG. 3) to the latch mechanism 300 in order to selectively release the latch mechanism 300 by operating the inner handle 141 or outer handle 142 of the rear door 140; the latch 200 is thereby in an unlocked state.

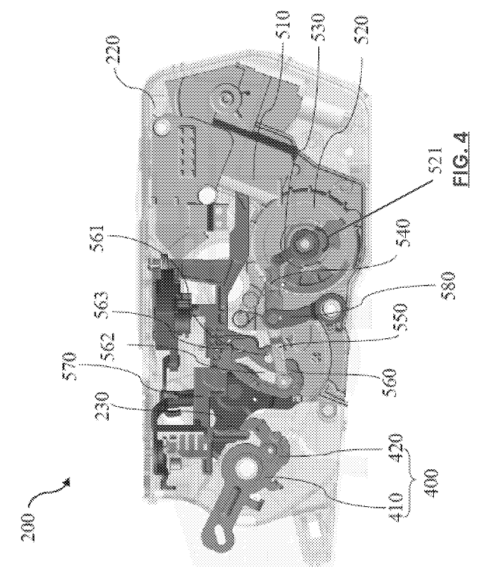

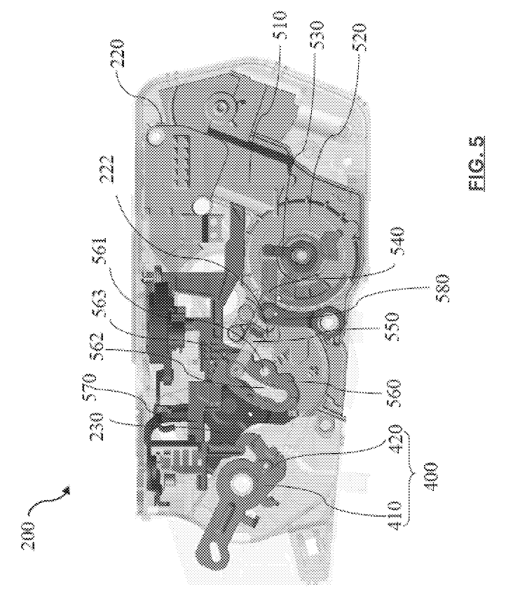

In one embodiment, as shown in FIGS. 3 to 7, the latch release mechanism 400 includes an auxiliary release member 410 and an abutment member 420. The auxiliary release member 410 is pivotably mounted on the support member 220 about an auxiliary release member pivot 411. The auxiliary release member 410 is connected to the inner handle 141 and/or the outer handle 142 (operable by the user) on the rear door 140. For example, the auxiliary release member 410 has an elongated cable hole 412 through which a cable, or Bowden cable, or rod (all not shown) passes to connect to the inner handle 141 and/or outer handle 142. The abutment member 420 is pivotably connected to the auxiliary release member 410. Specifically, the abutment member 420 is pivotable about an abutment member pivot 421 on the auxiliary release member 410 between an engagement position (FIGS. 3, 6, and 7) in which it can engage with the latch mechanism 300 in response to handle actuation so that the latch release mechanism 400 is coupled with the latch mechanism 300, and a disengaged position (FIGS. 4 and 5) in which it is disengaged from the latch mechanism 300 so that the latch release mechanism 400 is decoupled with the latch mechanism 300. The latch release mechanism 400 cannot engage with the latch mechanism 300 when the latch release mechanism 400 is uncoupled (e.g. see FIG. 4) from the latch mechanism 300 in order to selectively prevent the release of the latch mechanism 300 by operating the inner handle 141 and/or outer handle 142 of the rear door 140 depending on the connection configuration of the handle(s) to the latch release mechanism 400; the latch 200 is thereby in a locked state. Accordingly, the latch release mechanism 400 has a coupled state and an uncoupled state, and is switchable between these two states in order to respectively change the state of the latch 200 between an unlocked state and a locked state. A biasing member (not shown), such as a biasing spring, is provided on the abutment member 420 to bias the abutment member 420 toward its coupled position in which it can engage with the latch mechanism 300.

It should be noted that, as used herein, one component “engaging” another component may refer to direct engagement between the two components, or indirect engagement through an intermediate component. Accordingly, disengagement may refer to direct disengagement between two components that were previously engaged, or to the disengagement of at least one of the components from an intermediate component through which indirect engagement is made.

Specifically, in one embodiment of the present disclosure, as shown in FIGS. 2 to 7, the lock device 200 includes an intermediate engagement member 230. The latch release mechanism 400 indirectly engages with the latch mechanism 300 located on the first side of the support member 220 via the intermediate engagement member 230. The intermediate engagement member 230 is arranged on the second side of the support member 220, that is, on the side where the latch release mechanism 400 is located. The intermediate engagement member 230 extends through the through-slot 221 of the support member 220 to engage with the pawl 320 of the latch mechanism 300 located on the first side of the support member 220. An engagement protrusion 231 is provided on the intermediate engagement member 230 for engaging with the abutment member 420 of the latch release mechanism 400. When the abutment member 420 of the latch release mechanism 400 engages the engagement protrusion 231 of the intermediate engagement member 230, the latch release mechanism 400 indirectly engages with the pawl 320 of the latch mechanism 300 via the intermediate engagement member 230. In this case, when the latch release mechanism 400 is actuated mechanically through the inner handle 141 or outer handle 142 of the rear door 140, the pawl 320 is actuated to move against the biasing force of the pawl biasing member to its ratchet-releasing position, thereby allowing the ratchet 310 to move to its striker-release position so that the rear door 140 can open; the lock device 200 is considered released. Movement of latch release mechanism 400 by a cable 400 will urge the abutment member 420 against the engagement protrusion 231 to drive the movement of the intermediate engagement member 230 and thus a corresponding movement of the pawl 320 in the releasing direction (e.g. illustratively shown as the clockwise direction of FIG. 2) When the abutment member 420 of the latch release mechanism 400 is misaligned by controlled movement of a lock link acting on the abutment member 420 so as not to be able to disengage with the engagement protrusion 231 of the intermediate engagement member 230 when the auxiliary release member 410 is moved by a handle actuation, the latch release mechanism 400 is also disengaged from the pawl 320 of the latch mechanism 300. In this case, actuating the latch release mechanism 400 through the actuation of the inner handle 141 or outer handle 142 cannot actuate the pawl 320. The pawl 320 remains in its ratchet-holding position under the biasing force of the pawl biasing member, which keeps the ratchet 310 in its striker-capture position, preventing the rear door 140 from opening. The abutment member 420 of the latch release mechanism 400 cannot engage with the engagement protrusion 231 of the intermediate engagement member 230 when the abutment member 420 of the latch release mechanism 400 is misaligned from the engagement protrusion 231 of the intermediate engagement member 230 (e.g. see FIGS. 4, 5); thus, the latch release mechanism 400 is uncoupled from the latch mechanism 300 and the latch 200 is in a locked state.

As shown in FIGS. 3 to 7, switching between the coupled state and the uncoupled state of the latch release mechanism 400 with/from the latch mechanism 300 is carried out through a switching mechanism 500. Switching mechanism 500 is shown to illustratively include a lever assembly that is moved by an actuating unit to toggle a detent mechanism which shifts the lock linkbetween two states to couple and uncouple the latch release mechanism 400 as will be illustratively described herein below. The switching mechanism 500 illustratively includes the actuating unit having a motor 510 and an actuating gear 520, also referred to as a power release gear. The actuating gear 520 is driven by the motor 510. The motor 510 and the actuating gear 520 together provide an example of an “actuating unit,” where the motor 510 serves as the power component of the actuating unit and the actuating gear 520 serves as the output component of the actuating unit. The motor 510 can rotate in either direction to drive the actuating gear 520 from its original position, or home position (FIGS. 3, 5, and 7) either counterclockwise (as an example of the “first direction”, illustratively shown using arrow 521) toward an actuating position, or clockwise (as an example of the “second direction,” opposite the first direction) toward an additional actuating position. A gear biasing member 531, such as a biasing spring, is provided on the actuating gear 520 to bias it toward its original position. Illustratively, the gear biasing member biases the actuating gear 520 from the second actuating position back to the home position.

The switching mechanism 500 may be configured such that the latch release mechanism 400 is switched between the coupled state and the uncoupled state when the actuating gear 520 moves from its home position counterclockwise toward the actuating position. In accordance with the illustrated embodiment, the switching mechanism 500 is configured such that the latch release mechanism 400 is switched between the coupled state and the uncoupled state only when the actuating gear 520 moves from its home position (e.g. counterclockwise) toward the actuating position. That is, when the actuating gear 520 is driven by the motor 510 (e.g. clockwise) from the home position toward the additional actuating position such movement does not cause the latch release mechanism 400 to switch between the coupled and uncoupled states and the locked state of the latch 200 is changed; when the actuating gear 520 returns from the actuating position (e.g. clockwise) toward the home position under the biasing force of the gear biasing member, such as a spring 531 for example, such movement does not cause the latch release mechanism 400 to switch between the coupled and uncoupled states and the locked state of the latch 200 is not changed; when the actuating gear 520 returns from returns from the additional actuating position, or releasing position, (e.g. counterclockwise) toward the home position, such movement does not cause the latch release mechanism 400 to switch between the coupled and uncoupled states and the locked state of the latch 200 is not changed. The switching mechanism 500 is configured such that the latch release mechanism not switched when the actuating unit returns toward the home position or moves in an opposite second direction. This configuration prevents undesired switching of the latch release mechanism 400 when the actuating gear 520 returns to the home position after the motor 510 stops operating, allowing the latch release mechanism 400 to remain in its desired state. Additionally, since switching of the latch release mechanism 400 occurs only in one direction of actuation, the actuation of the actuating unit in the opposite direction may be used for other functional requirements, such as a power release function.

As shown in FIGS. 3 to 7, in order to ensure that the latch release mechanism 400 is switched between the coupled state and the uncoupled state only when the actuating gear 520 moves from the home position toward the actuating position (e.g. in the counterclockwise direction), the switching mechanism 500 illustratively further includes an actuating arm 530, a first drive arm 540, a second drive arm 550, a rocker 560 as an example of bi-stable mechanism, and a sliding member 570. Sliding member 570 is an example of a lock link that is movable to change the coupled or uncoupled state of the latch release mechanism 400. Sliding member 570 is shown to be associated with latch release mechanism 400, but in another possible configuration, sliding member 570 may also be used to additionally couple and decouple another latch release mechanism 401. Providing two latch release mechanism allows latch release mechanism 400 to be associated with one of an inside or outside door handle, while the another latch release mechanism 401 may be associated with the other one of the inside or outside door handle, and thus movement of the lock link can simultaneously change the coupling/decoupling state of the latch release mechanism 400, 401 with the latch mechanism 300. Optionally, the switching mechanism 500 further includes a return arm 580. Return arm 580 is pivotally mounted to the support member 220 at pivot connection 552, and is not pivotally mounted to the actuating gear 520. The actuating arm 530 is connected to the actuating gear 520 so as to move together with the actuating gear 520. The actuating arm 530 has an original (home) position corresponding to the home position of the actuating gear 520, and an actuating position corresponding to the actuating position of the actuating gear 520. One end of the first drive arm 540 is a free end that is located in the movement path of the actuating arm 530 as the actuating arm 530 moves from the home position in the counterclockwise direction. The other end of the first drive arm 540 is a connecting end located within a guide slot 222 provided in a rocker 560 pivotally supported on the support member 220 at a pivot point 561. First drive arm 540 may be pivotably connected to one end of the second drive arm 550, with the ends of the first drive arm 540 and the second drive arm 550 being movable within the guide slot 222. One end of the return arm 580 is a pivot end pivotably mounted on the support member 220 through a return arm pivot 581. The other end of the return arm 580 is a connecting end pivotably connected to the first drive arm 540 and the second drive arm 550 within the guide slot 222. An arm biasing member (not shown), such as a biasing spring, is provided at the pivot end of the return arm 580 to bias the return arm 580, and thus the first drive arm 540 and the second drive arm 550 connected thereto, toward the actuating arm 530 (in the clockwise direction). First drive arm 540, return arm 580 and second drive arm 550 illustratively form the lever assembly 579. As used herein, the term ‘lever assembly’ refers to a set of components operably coupling the actuating unit to the detent mechanism. In one possible configuration of a lever assembly 579, lever assembly 579 includes return arm 580 having a free end, and having a second drive arm 500 pivotally coupled to the return arm 580 between the free end and return arm pivot 581. The actuating arm 530 may engage directly with the free end of the return arm 580 such that second drive arm 550 will be actuated, or moved, to toggle the detent mechanism when return arm 580 is actuated by the actuating arm 530 by urging the free end.

Actuating arm 530 may include an actuating surface, such as a cam surface 532. In one possible configuration, cam surface 532 has an elongated contact surface having a curved profile which can slidably engage against a surface 541 of the lever assembly 579, illustrated as a surface of the first drive arm 540. Cam surface 532 may limit the forces and distances of actuation applied by the motor 510 e.g. limit the application of the stall forces of the motor 510 to the lever assembly 579. When actuating unit returns from the actuating position to the home position, cam surface 532 may disengage from contact with the surface 541 of the lever assembly 579 and may optionally further become separated by a gap formed between the surface 541 and cam surface 532. Lever assembly 579 is not permanently pivotally mounted on the power release gear 520, for example such as via a pivot arrangement on the power release gear 520.

As shown in FIGS. 3 to 7, the rocker 560 is pivotably mounted on the support member 220 about a rocker pivot 561. Rocker 560 is shown as pivotable about a rocker pivot 561 between two detent positions: (i) a locking position as seen in FIG. 4 and FIG. 5, and (ii) an unlocking position as seen in FIGS. 3, 6 and 7. Each position is a stable position, meaning that without external forces applied to the rocker 560, the rocker 560 will maintain its current position. A detent spring may be provided to establish the two stable positions of the rocker 560. A rocker slot 562 is formed in the rocker 560. The rocker slot 562 is arcuate. The rocker pivot 561 is located outside the rocker slot 562 and lies between two end portions of the rocker slot 562 along its length. The other end of the second drive arm 550 is disposed within the rocker slot 562 and is movable therein. Second drive arm 550 acts as a push rod to move the rocker 560. Rocker 560 may be provided to actuate the lock link (e.g. sliding member 570) to control the coupled or uncoupled state of the latch release mechanism 400 or both the first and second latch release mechanisms 400, 401. While lock link is illustratively shown as a slidable element, such as shown herein by sliding member 570, but also may be a pivotable element. Sliding member 570 is shown to be and elongated link, having a length extending along its longitudinal axis.

As shown in FIGS. 3 to 7, the sliding member 570 is arranged on the support member 220 so as to be slidable left and right between a first end position and a second end position. The sliding member 570 can abut the latch release mechanism 400; and also it interacts with the rocker 560. Specifically, the sliding member 570 can abut the abutment member 420 of the latch release mechanism 400 such that, when the sliding member 570 moves, the latch release mechanism 400 is able to switch between the coupled state and the uncoupled state. When the sliding member 570 moves toward the direction pushing against the abutment member 420 (to the right in FIGS. 3 to 7) toward the first end position, the sliding member 570 can cause the abutment member 420 to disengage from the engagement protrusion 231 and thus disengage from the latch mechanism 300. When the sliding member 570 reaches the first end position, the abutment member 420 is completely misaligned from the engagement protrusion 231. When the sliding member 570 moves toward the direction away from the abutment member 420 (to the left in FIGS. 3 to 7) toward the second end position, the abutment member 420 returns to its engagement position under the biasing force of the biasing member of the abutment member 420, and thus is able to re-engage with the latch mechanism 300. When the sliding member 570 reaches the second end position, the abutment member 420 is able to fully return to its engagement position with the latch mechanism 300. The sliding member 570 is coupled to the rocker 560 at a coupling portion 563 different from the rocker pivot 561. A detent spring (not shown) is provided at the coupling portion 563 of the rocker 560 so that, when the sliding member 570 is stationary, the sliding member 570 can be held at either the first end position or the second end position without remaining at an intermediate position between the two.

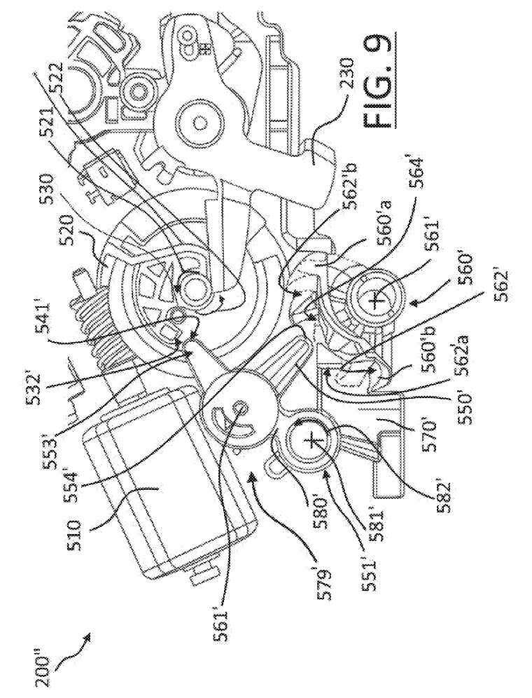

In this embodiment, the first drive arm 540, the second drive arm 550, the rocker 560, and the return arm 580 together form an example of the lever assembly 479. Other combination or sub-combinations of levers are possible to form other embodiments of lever assembly. In another possible embodiment as will be described herein below in further details with reference to FIG. 9, the second drive arm 550 and the return arm 580 together form an example of a lever assembly. The lever assembly 579 is configured such that, when the actuating arm 530 moves from the original position in the counterclockwise direction toward the actuating position, it drives the sliding member 570 to move between the two end positions; and when the actuating arm 530 moves from the actuating position in the clockwise direction toward the original position, the sliding member 570 remains stationary. When the sliding member 570 moves, the latch release mechanism 400 can switch between the coupled state.

The working principle of the switching mechanism 500 for switching the state of the latch release mechanism 400 will now be described in detail with reference to FIGS. 3 to 7.

FIG. 3 shows a schematic view in which the actuating gear 520 of the switching mechanism 500 is in the home position and the latch release mechanism 400 is in the coupled state, where the abutment member 420 is in alignment with the engagement protrusion 231 such that an actuation of auxiliary release member 410 will cause a movement of the pawl 320 away from a ratchet holding position of FIG. 2 to a ratchet releasing position to release the latch 200. In this state, the end of the second drive arm 550 located within the rocker slot 562 abuts one end of the rocker slot 562. FIG. 4 shows a schematic view in which the actuating gear 520 moves from the home position shown in FIG. 3 in a counterclockwise direction during a first actuation into the actuating position, and the latch release mechanism 400 is in the uncoupled state. As shown in FIGS. 3 and 4, when the motor 510 operates in one direction such that the actuating gear 520 moves counterclockwise from the home position shown in FIG. 3, the actuating arm 530 connected to the actuating gear 520 also moves counterclockwise from the corresponding home position. As the free end of the first drive arm 540 having the surface 541 lies in the movement path of the actuating arm 530 as it moves counterclockwise from the home position, the actuating arm 530 contacts the free end of the first drive arm 540 and, during continued movement, pushes the first drive arm 540 and the second drive arm 550 connected to the first drive arm 540 to move within the guide slot 222. In one possible configuration, the cam surface 532 of the actuating arm 530 contacts the surface 541 of the free end of the first drive arm 540. Cam surface 532 can be provided as a part of the actuating arm 530 as a lever, or as a molded element protruding from the power release gear 520. During this process, the end of the second drive arm 550 abutting one end of the rocker slot 562 drives the rocker 560 to pivot about the rocker pivot 561 as the second drive arm 550 moves with the first drive arm 540. This causes the rocker 560 to drive the sliding member 570 to move toward the right (as shown in FIGS. 3 and 4) toward the first end position. The movement of the sliding member 570 forces the abutment member 420 (which abuts the sliding member 570) to pivot about the abutment member pivot 421 against the biasing force of the biasing member on the abutment member 420, thereby disengaging the abutment member 420 from the engagement protrusion 231 of the intermediate engagement member 230. Thus, the latch release mechanism 400 is in the uncoupled state.

FIG. 5 shows a schematic view in which the actuating gear 520, after being actuated counterclockwise for the first time as shown in FIG. 4 to an actuating position from a home position as shown in FIG. 3, returns from the actuating position clockwise to the original position (also referred to as the home position), and the latch release mechanism 400 remains in the uncoupled state. As shown in FIGS. 4 and 5, when the motor 510 stops operating, the actuating gear 520 moves clockwise from the actuating position toward the home position under the biasing force of the gear biasing member. The actuating arm 530 connected to the actuating gear 520 also moves clockwise from the corresponding actuating position toward its home position. During this process, the actuating arm 530 no longer exerts force on the first drive arm 540. The first drive arm 540 and the second drive arm 550 move toward the actuating arm 530 within the guide slot 222 under the biasing force of the arm biasing member of the return arm 580. During this process, the rocker slot 562 allows the end of the second drive arm 550 to move within the slot, and this movement does not cause the rocker 560 to pivot about the rocker pivot 561. Therefore, the rocker 560 does not drive the sliding member 570 to move. The detent spring between the rocker 560 and the sliding member 570 at the coupling portion 563 keeps the sliding member 570 in the first end position, so the state of the latch release mechanism 400 does not change—the latch release mechanism 400 remains in the uncoupled state.

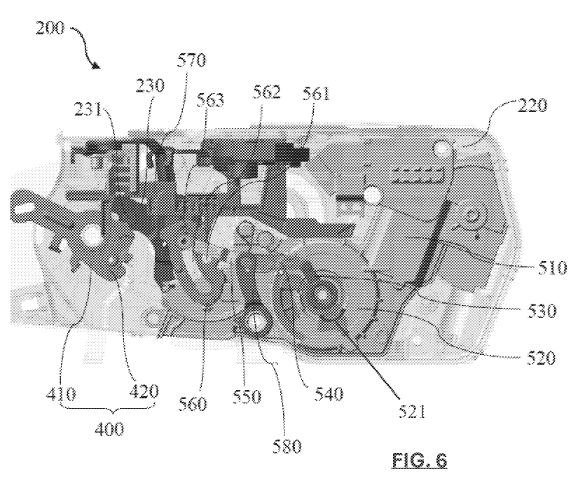

FIG. 6 shows a schematic view in which the actuating gear 520, beginning from the original position shown in FIG. 5, moves counterclockwise again for a second actuation into the actuating position, and the latch release mechanism 400 is in the uncoupled state. In this state, the end of the second drive arm 550 that lies within the rocker slot 562 abuts the opposite end of the rocker slot 562. As shown in FIGS. 5 and 6, when the motor 510 performs a second, separate, actuation in the same direction, the actuating gear 520 is driven by the motor 510 from the original position shown in FIG. 5 to move counterclockwise again. The actuating arm 530 connected to the actuating gear 520 also moves counterclockwise from the corresponding original position. Since the free end of the first drive arm 540 is located in the movement path of the actuating arm 530 as it moves counterclockwise, the actuating arm 530 contacts the free end of the first drive arm 540 and, during continued movement, pushes the first drive arm 540 and the second drive arm 550 connected thereto to move within the guide slot 222. During this process, the end of the second drive arm 550 abutting the other end of the rocker slot 562 drives the rocker 560 to pivot about the rocker pivot 561 as the second drive arm 550 moves with the first drive arm 540. This causes the rocker 560 to drive the sliding member 570 to move toward the left (as shown in FIGS. 5 and 6) toward the second end position. Under the biasing force of the biasing member of the abutment member 420, the abutment member 420 returns to the position where it once again actuate the intermediate engagement member 230. Thus, the latch release mechanism 400 is in the coupled state.

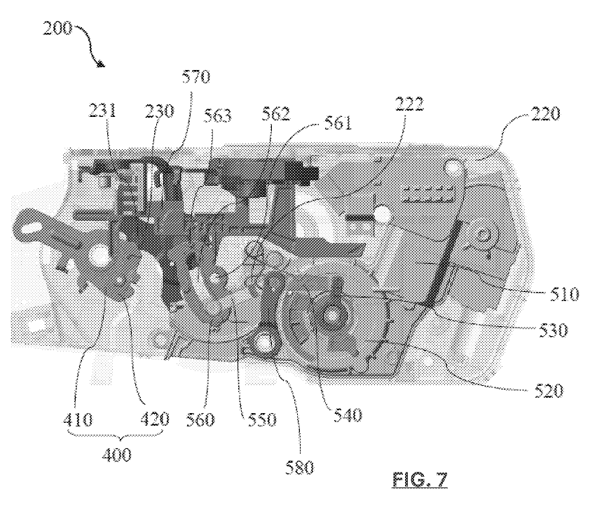

FIG. 7 shows a schematic view in which the actuating gear 520, after the second counterclockwise actuation shown in FIG. 6, returns clockwise from the actuating position to the original position, and the latch release mechanism 400 remains in the coupled state. As shown in FIGS. 6 and 7, when the motor 510 stops operating, the actuating gear 520 moves clockwise from the actuating position toward the home position under the biasing force of the gear biasing member. The actuating arm 530 connected to the actuating gear 520 also moves clockwise from the corresponding actuating position toward its home position. During this process, the actuating arm 530 no longer exerts force on the first drive arm 540. The first drive arm 540 and the second drive arm 550 move toward the actuating arm 530 within the guide slot 222 under the biasing force of the arm biasing member of the return arm 580. During this process, the rocker slot 562 allows the end of the second drive arm 550 to move within the slot, which does not cause the rocker 560 to pivot about the rocker pivot 561. Consequently, the rocker 560 does not drive the sliding member 570 to move. The detent spring at the coupling portion 563 between the rocker 560 and the sliding member 570 keeps the sliding member 570 in the second end position, so the state of the latch release mechanism 400 does not change—the latch release mechanism 400 remains in the coupled state.

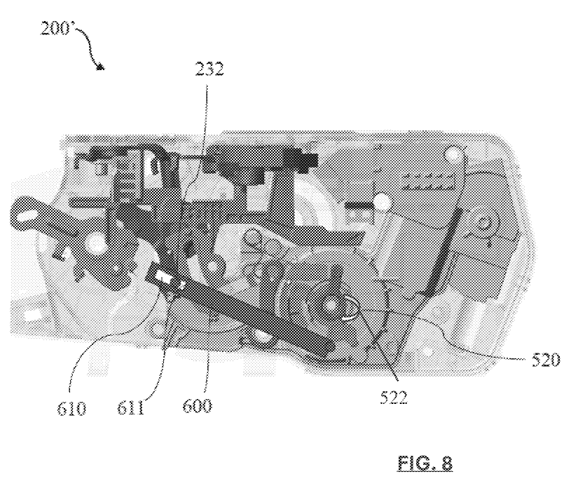

FIG. 8 is a schematic view of another embodiment of the lock device 200' used in the motor vehicle 100 and based upon the previous embodiment shown in FIG. 1, having like configurations in addition to configurations now described. The lock device 200' shown in FIG. 8 is generally similar to the lock device 200 shown in FIGS. 2 to 7. The difference lies in that, in addition to including the manually operable latch release mechanism 400 of the first embodiment, the lock device 200' further includes an additional latch release mechanism driven electrically by the actuating unit. In particular, a power release function is provided.

As shown in FIG. 8, the additional latch release mechanism is illustrated as an additional release arm 600. One end of the additional release arm 600 is connected to the actuating gear 520 so that it is driven by the actuating gear 520. The other end of the additional release arm 600 engages the latch mechanism 300. For example, the other end of the additional release arm 600 indirectly engages the latch mechanism 300 through the intermediate engagement member 230. The additional release arm 600 and the intermediate engagement member 230 engage in a manner that allows idle motion between them. Specifically, an idle-motion slot 610 is formed at the other end of the additional release arm 600, and the idle-motion slot 610 extends along the length of the additional release arm 600. An additional engagement protrusion 232 is provided on the intermediate engagement member 230 and engages within the idle-motion slot 610. The position of the additional engagement protrusion 232 within the idle-motion slot 610 is arranged such that, when the actuating gear 520 moves from the home position counterclockwise to the actuating position as described above, the idle-motion slot 610 moves relative to the additional engagement protrusion 232, and the additional engagement protrusion 232 does not contact the end 611 of the idle-motion slot 610; when the actuating gear 520 moves from the home position clockwise, the additional engagement protrusion 232 can contact the end 611 of the idle-motion slot 610. Therefore, when the actuating gear 520 moves from the home position counterclockwise toward the actuating position, the additional engagement protrusion 232 does not contact the end 611 of the idle-motion slot 610, and the idle-motion slot 610 merely moves relative to the additional engagement protrusion 232 without actuating the latch mechanism 300 through the intermediate engagement member 230. When the actuating gear 520 moves from the home position clockwise toward an additional actuating position, the additional engagement protrusion 232 contacts the end 611 of the idle-motion slot 610 such that the additional release arm 600, as it moves with the actuating gear 520, can actuate the pawl 320 of the latch mechanism 300 via the intermediate engagement member 230, causing the pawl 320 to move to the ratchet-releasing position, thereby allowing the ratchet 310 to move to its striker-release position. In other words, the additional release arm 600 moves the latch mechanism 300 only when the actuating gear 520 moves clockwise from the home position. A power release function is provided when the actuating gear 520 moves from the home position clockwise toward the additional actuating position. The actuating unit is configured to engage with the latch mechanism (optionally via an intermediate engagement member) to release the lock device when the actuating unit moves toward a releasing position 522 (e.g., an additional actuating position in the second direction 521. The term ‘releasing position’ refers to a rotational position of the actuating gear 520 in the second direction 522 in which the actuating arm 530 actuates the pawl 320 to move to the ratchet-releasing position.

In the lock device 200' according to another embodiment shown in FIG. 8, counterclockwise actuation output by the actuating gear 520 in the first direction 521 of the actuating unit can be used to switch the latch release mechanism 400 between its coupled and uncoupled states, and clockwise (e.g. arrow 522) actuation output by the actuating gear 520 of the actuating unit can be used to automatically release the latch mechanism 300 through the additional latch release mechanism to provide a power release operation. That is, a single actuating unit is capable of selectively performing multiple functions, thereby reducing the size and weight of the lock device 200', lowering the cost of the actuating unit, and improving design flexibility for the vehicle closure panel.

It should be understood that various different embodiments may be devised by combining or modifying different embodiments and technical features described herein in various ways.

Now additionally referring to FIG. 9, another embodiment of lock device 200” is shown having another possible configuration of lever assembly 579, but now shown with using reference numeral 579’. Lock device 200” is based upon the previous embodiments shown in FIGS. 1 to 8, having like configurations in addition to configurations now described. Lever assembly 579’ is shown having a reduced number of levers as compared to previous embodiment, and illustratively includes a return arm 580’ that is pivotally mounted to the support member 220 at a first end 551’ of return arm 580’ via a pivot connection 581’. Return arm 580’ is configured to be biased in a counterclockwise direction towards a home position as shown in FIG. 9, as represented by arrow 582’, and away from a rocker 560’. Return arm 580’ includes an opposite second end 553’ that acts as the contact surface 541’ for power release gear 520 moving towards the actuating direction in the first direction 521. A second drive arm 550’ is pivotally mounted on the return arm 580’ about a pivot point 561’, and is configured to rotate in the clockwise and counterclockwise directions about the pivot point 561’. The second drive arm 550’ may be biased in a central home position between these directions by a homing spring (not shown). Second drive arm 550’ has a push end 554’ that is adapted to push a rocker 560’ between two bi-stable positions. Rocker 560’ is pivotally connected to the lock link shown as a sliding member 570 in FIG. 9 at pivot 561’ and is moveable between two detent, or two stable positions by movement of the second drive arm 550’ acting on a first receptacle 562’ and a second receptacle 564’. Rocker 560’ is another example of a bi-stable mechanism. Movement of the second drive arm 550’ acting on one of the first receptacle 562’ or the second receptacle 564’ rotates the rocker 560’ from a first position shown using reference numeral 560’b to a second position shown in dotted outline and using reference numeral 560’a. Depending on the position of the rocker 560’, a central peak between the two valleys of the receptacles 562’, 564’ will be presented to the second drive arm 550’ so as to intercept and guide the push end 554’ into one of the first receptacle 562’ or a second receptacle 564’. In doing the rocker 560’ will be urged to rotate and change for the alignment of the first receptacle 562’ or a second receptacle 564’ with respect to the push end 554’ once the push end 554’ has been retracted out of the first receptacle 562’ or a second receptacle 564’ due bias 582’ acting on the return arm 580’ after the gear 520 has been returned to the home position from the actuating position. Upon the next subsequent plunge of the second drive arm 550’ towards the rocker 560’, the push end 554’ will be aligned with the other one of the first receptacle 562’ or a second receptacle 564’ and the rocker 560’ will be rotated from the second position to the first position. During rotation of the rocker 560’ between these stable positions, the lock link (shown as a sliding member 570) will be caused to move between two positions, where one position is associated with a coupled state of the latch release mechanism 400 and another position that is associated with a decoupled state of the latch release mechanism 400, as previously described herein above. Thus, a locked/unlocked state of the latch 200’’ may toggle between two bistable positions. Only the unidirectional direction of the plunger of the second drive arm 550’ only in a direction towards the rocker 560’ push end 554’ into one of the first receptacle 562’ or a second receptacle 564’ corresponding with the rotation of the gear 520 from the home position to the actuating position can change the position of the rocker 560’ between the two stable states. It is recognized that other types of such bistable mechanisms are possible. For example, such bistable mechanisms may be a bistable linear mechanism illustratively formed using detent mechanism e.g. rocker 560, 560’ and a linear push rod e.g. 550, 550’. Rotation of the gear 520 in the clockwise direction, or second direction, will cause a power release cam surface 533’ of the power release gear 520 to contact and move a release lever that is operable coupled to the pawl 320, such as intermediate engagement member 230.

The present configurations have been described above with reference to specific embodiments. It will be understood that the foregoing description is merely exemplary and not limiting. Various modifications and variations may be conceived by those skilled in the art in light of the above description without departing from the scope of the disclosure. Such modifications and variations are intended to fall within the scope of the present application.

What is claimed is:

1. A lock device for a motor vehicle door, the lock device comprising:
a support member;
a latch mechanism mounted to the support member;
a latch release mechanism having a coupled state and an uncoupled state, wherein in the coupled state the latch release mechanism is able to actuate the latch mechanism, and in the uncoupled state the latch release mechanism when actuated is unable to actuate the latch mechanism;
an actuating unit; and
a switching mechanism operably coupled to the actuating unit, the switching mechanism configured to switch the latch release mechanism between the coupled state and the uncoupled state only when the actuating unit moves from a home position toward an actuating position.

2. The lock device of claim 1, wherein the actuating unit is configured to return to the home position from the actuating position under the influence of a spring bias.

3. The lock device of claim 1, wherein the actuating unit is configured to engage with the latch mechanism to release the lock device when the actuating unit moves toward a releasing position.

4. The lock device of claim 1, wherein the switching mechanism comprises a bistable mechanism to change the latch release mechanism between the coupled state and the uncoupled state.

5. The lock device of claim 4, wherein the actuating unit comprises a power release gear having a cam surface and a motor operably coupled to the power release gear for rotating the power release gear in a first direction and in a second direction.

6. The lock device of claim 5, wherein the cam surface is configured to push against a surface of the switching mechanism when the actuating unit moves from the home position toward the actuating position.

7. The lock device of claim 6, wherein the cam surface is configured to slide against the surface of the switching mechanism when the actuating unit moves from the home position toward the actuating position.

8. The lock device of claim 7, wherein the cam surface is configured to disengage from the surface of the switching mechanism when the actuating unit moves from the actuating position to the home position.

9. The lock device of claim 1, wherein the switching mechanism comprises a rocker, wherein the actuating unit is configured to toggle the rocker between a locking position in which the latch release mechanism is in the uncoupled state, and an unlocking position in which the latch release mechanism is in the coupled state.

10. The lock device of claim 9, wherein the switching mechanism comprises a lever assembly operably coupled to the actuating unit and to the rocker, wherein the lever assembly is not pivotally mounted on the power release gear.

11. The lock device of claim 10, wherein the lever assembly comprises a return arm pivotally coupled to the support member, wherein the return arm is pivoted by the actuating unit, and wherein the pivoting of the return arm causes the latch release mechanism to switch between the coupled state and the uncoupled state.

12. The lock device of claim 11, wherein the lever assembly further comprises a second drive arm pivotally mounted to the return arm, wherein the cam surface is configured to slidably engage against a surface of the return arm to cause the second drive arm to move and engage with the rocker.

13. The lock device of claim 11, wherein the return arm is biased towards a non-actuated position, and wherein the cam surface is configured to move the return arm against the bias toward an actuated position as the actuating unit moves toward the actuating position.

14. The lock device of claim 9, further comprising a lock link operably coupled to the rocker and to the latch release mechanism, wherein the lock link is movable by the rocker to switch the latch release mechanism between the coupled state and the uncoupled state.

15. The lock device of claim 14, wherein the lock link is a sliding member.

16. The lock device of claim 1, wherein the latch release mechanism is associated with one of an inside door handle and an outside door handle.

17. The lock device of claim 16,
wherein the lock link is slidably movable in a direction along its longitudinal axis;
wherein the latch release mechanism is associated with the inside door handle, the latch release mechanism comprises a coupled state to connect the inside door handle to the latch mechanism and the uncoupled state to disconnect the inside door handle from the latch mechanism;
wherein the lock device comprises another latch release mechanism that is associated with the outside door handle, wherein the other latch release mechanism comprises a coupled state to connect the outside door handle to the latch mechanism and the uncoupled state to disconnect the outside door handle from the latch mechanism; and
wherein the switching mechanism is operably coupled to the lock link to cause the lock link to move and change the states of both the latch release mechanism and the other latch release mechanism.

18. The lock device of claim 1, wherein the switching mechanism is configured such that the latch release mechanism is not switched when the actuating unit returns toward the home position from the actuating position.

19. The lock device of claim 1, wherein:
the support member is a frame plate;
the latch mechanism comprises:
a ratchet pivotally supported on the frame plate by a ratchet pin, the ratchet being movable between a striker-release position and a striker-capture position, being biased toward the striker-release position, and having a closing notch; and
a pawl pivotally supported on the frame plate by a pawl pin for movement between a ratchet-holding position and a ratchet-releasing position, the pawl being biased toward the ratchet-holding position;
wherein the latch release mechanism is able to move the pawl from the ratchet-holding position to the ratchet-releasing position when the latch release mechanism is in the coupled state, and wherein the latch release mechanism is unable to move the pawl from the ratchet-holding position to the ratchet-releasing position when the latch release mechanism is in the uncoupled state.

20. A lock device for a motor vehicle door, the lock device comprising:
a support member;
a latch mechanism having a ratchet and a pawl mounted to the support member;
a latch release mechanism operably connected to a door handle and to the pawl, wherein the latch release mechanism has a coupled state and an uncoupled state, wherein in the coupled state the door handle is able to actuate the pawl, and in the uncoupled state the door handle when actuated is unable to actuate the latch mechanism;
a bistable mechanism operable to switch the latch release mechanism between the coupled state and the uncoupled state; and
an actuating unit having a power release gear moveable away from a home position in a first direction and moveable away from the home position in a second opposite direction;
wherein the power release gear is operable to move the pawl when moved away from the home position in a second opposite direction, and wherein the power release gear is operable to actuate the bistable mechanism to switch the latch release mechanism between the coupled state and the uncoupled state only when the power release gear moves from the home position in the first direction.
